(19) United States
(12) Patent Application Publication
(10) Pub. No.: US 2005/0229163 A1
(43) Pub. Date: Oct. 13, 2005

(54) Thread-scoped breakpoints

(75) Inventors: Cary Lee Bates, Rochester, MN (US); Paul W. Buenger, Eau Claire, WI (US)

Correspondence Address: Robert R. Williams;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/821,148

(22) Filed: Apr. 8, 2004

(51) Int. Cl. G06F 9/44

(52) U.S. Cl. 717/129

(57) ABSTRACT

A method, apparatus, system, and signal-bearing medium that in an embodiment halt execution of a thread upon encountering a scoped breakpoint if the thread previously encountered an entry breakpoint. If the thread did not previously encounter the entry breakpoint, then execution of the thread continues. The scoped breakpoint is within a region bounded by the entry breakpoint and an optional end breakpoint. The entry breakpoint is executed conditionally. When the thread encounters the entry and end breakpoints, thread execution is allowed to continue. In this way, multiple threads may be easier to debug because the user is allowed to specify breakpoints that are specific to threads that execute through a particular location in a program.

### CROSS-REFERENCE TO RELATED APPLICATION

The present application is related to the following co-pending application, which is filed on even date herewith and incorporated herein by reference: Attorney Docket Number ROC920030371US1, “Method and Apparatus for Breakpoint Analysis of Computer Programming Code Using Unexpected Code Path Conditions.”

### FIELD

An embodiment of the invention generally relates to computer software. In particular, an embodiment of the invention generally relates to thread-specific breakpoints in computer software.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware (such as semiconductors, integrated circuits, programmable logic devices, programmable gate arrays, and circuit boards) and software, also known as computer programs. As advances in semiconductor processing and computer architecture push the performance of the computer hardware higher, more sophisticated and complex computer software has evolved to take advantage of the higher performance of the hardware, resulting in computer systems today that are much more powerful than just a few years ago.

As the sophistication and complexity of computer software increase, the more difficult the software is to debug. Bugs are problems, faults, or errors in a computer program. Locating, analyzing, and correcting suspected faults in a computer program is a process known as “debugging.” Typically, a programmer uses another computer program commonly known as a “debugger” to debug a program under development.

Conventional debuggers typically support two primary operations to assist a computer programmer. A first operation supported by conventional debuggers is a “step” function, which permits a computer programmer to process instructions (also known as “statements”) in a computer program one-by-one and see the results upon completion of each instruction. While the step operation provides a programmer with a large amount of information about a program during its execution, stepping through hundreds or thousands of program instructions can be extremely tedious and time consuming and may require a programmer to step through many program instructions that are known to be error-free before a set of instructions to be analyzed are executed.

To address this difficulty, a second operation supported by conventional debuggers is a breakpoint operation, which permits a computer programmer to identify with a breakpoint a precise instruction for which it is desired to halt execution of a computer program during execution. As a result, when a computer program is executed by a debugger, the program executes in a normal fashion until a breakpoint is reached. The debugger then stops execution of the program and displays the results of the program to the programmer for analysis.

Typically, step operations and breakpoints are used together to simplify the debugging process. Specifically, a common debugging operation is to set a breakpoint at the beginning of a desired set of instructions to be analyzed and then begin executing the program. Once the breakpoint is reached, the debugger halts the program, and the programmer then steps through the desired set of instructions line-by-line using the step operation. Consequently, a programmer is able to more quickly isolate and analyze a particular set of instructions without needing to step through irrelevant portions of a computer program.

Thus, once the programmer determines the appropriate places in the program and sets breakpoints at those appropriate places, the breakpoints can be a powerful tool. But, many breakpoints may be needed, and the breakpoints needed may change over time as the programmer gains more information about the problem being debugged. Hence, determining the appropriate places in the program, setting breakpoints at those places, and removing the breakpoints that are no longer needed can be an arduous task.

The difficulty in managing breakpoints is exacerbated when the program being debugged executes in multiple jobs. A job is a single process or task that is performed by the computer. Each job consists of allocated memory known as working storage and one or more execution states known as threads, which follow the control flow of program code saved in working storage. Jobs have unique designators associated with them for the purpose of identifying a particular job. A user who desires to perform a specific computer operation designates the execution path corresponding to the operation, and the computer accordingly creates the associated job. A computer processor in turn executes the created job, and the user's desired operation is initiated. A computer processor cycles through a sequence of jobs, generally servicing in some capacity each job.

One of the problems with debugging threads is that the user often has difficulty determining in which thread to set a breakpoint because prior to execution, the user does not know which thread will encounter the problem of interest since the problems being debugged are often data or timing dependent.

Without a better way to debug programs that run in multiple threads, the debugging process will continue to be a difficult and time-consuming task, which delays the introduction of software products and increases their costs.

### SUMMARY

A method, apparatus, system, and signal-bearing medium are provided that in an embodiment halt execution of a thread upon encountering a scoped breakpoint if the thread previously encountered an entry breakpoint. If the thread did not previously encounter the entry breakpoint, then execution of the thread continues. The scoped breakpoint is within a region bounded by the entry breakpoint and an optional end breakpoint. The entry breakpoint is executed conditionally. When the thread encounters the entry and end breakpoints, thread execution is allowed to continue. In this way, multiple threads may be easier to debug because the user is allowed to specify breakpoints that are specific to threads that execute through a particular location in a program.

### BRIEF DESCRIPTION OF THE DRAWINGS

FIG. 1 depicts a block diagram of an example system for implementing an embodiment of the invention.

FIG. 2 depicts a block diagram of an example data structure for a breakpoint table, according to an embodiment of the invention.

FIG. 3 depicts a block diagram of an example user interface for entering a start of a region, according to an embodiment of the invention.

FIG. 4 depicts a block diagram of an example user interface for entering automatic thread breakpoints, according to an embodiment of the invention.

FIG. 5 depicts a block diagram of an example user interface for entering an end of a region, according to an embodiment of the invention.

FIG. 6 depicts a flowchart of example processing for a debug controller, according to an embodiment of the invention.

FIG. 7 depicts a flowchart of example processing for a setup automated thread breakpoint function in a debug controller, according to an embodiment of the invention.

FIG. 8 depicts a flowchart of example processing for a process scoped breakpoint function in a debug controller, according to an embodiment of the invention.

FIG. 9 depicts a flowchart of example processing for a process end breakpoint function in a debug controller, according to an embodiment of the invention.

### DETAILED DESCRIPTION

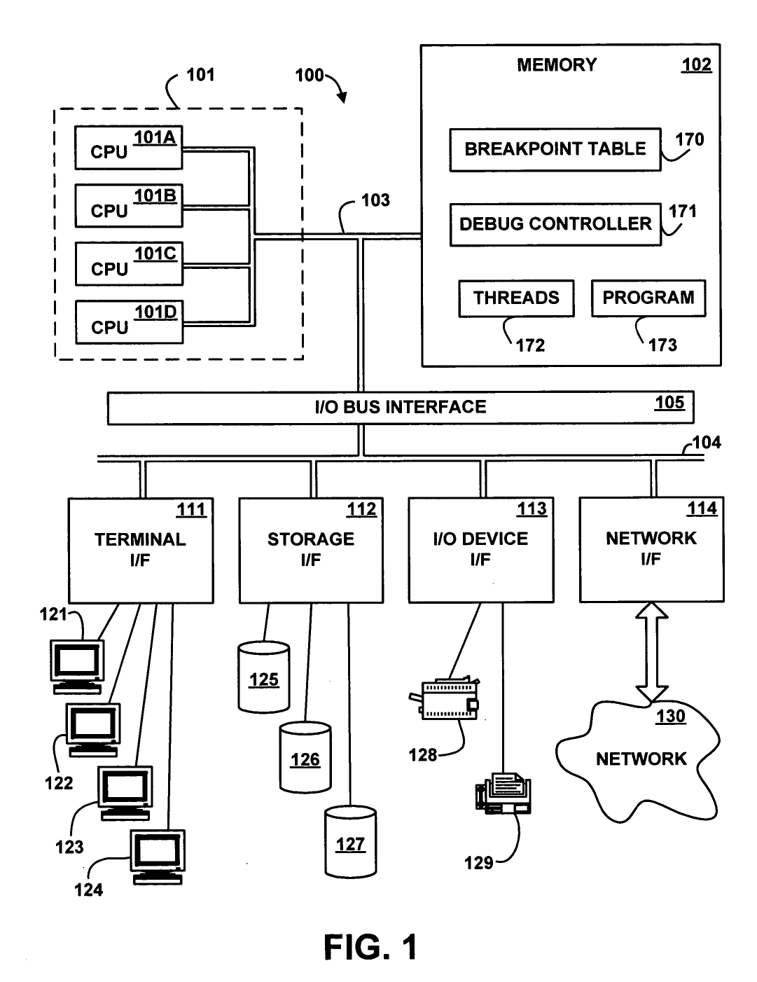

Referring to the Drawing, wherein like numbers denote like parts throughout the several views, FIG. 1 depicts a high-level block diagram representation of a computer system 100, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. E.g., memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes a breakpoint table 170, a debug controller 171, threads 172, and a program 173. Although the breakpoint table 170, the debug controller 171, the threads 172, and the program 173 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the breakpoint table 170, the debug controller 171, the threads 172, and the program 171 are illustrated as residing in the memory 102, these elements are not necessarily all completely contained in the same storage device at the same time.

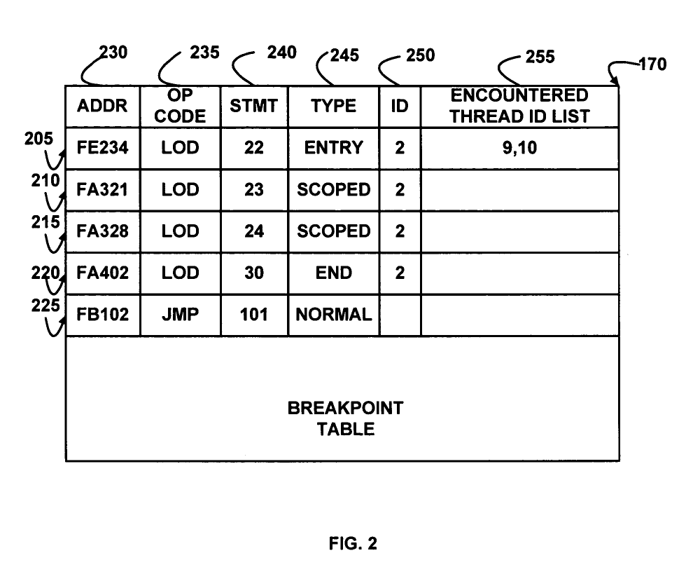

The breakpoint table 170 includes data that describes breakpoints in the threads 172. The breakpoint table 170 is further described below with reference to FIG. 2.

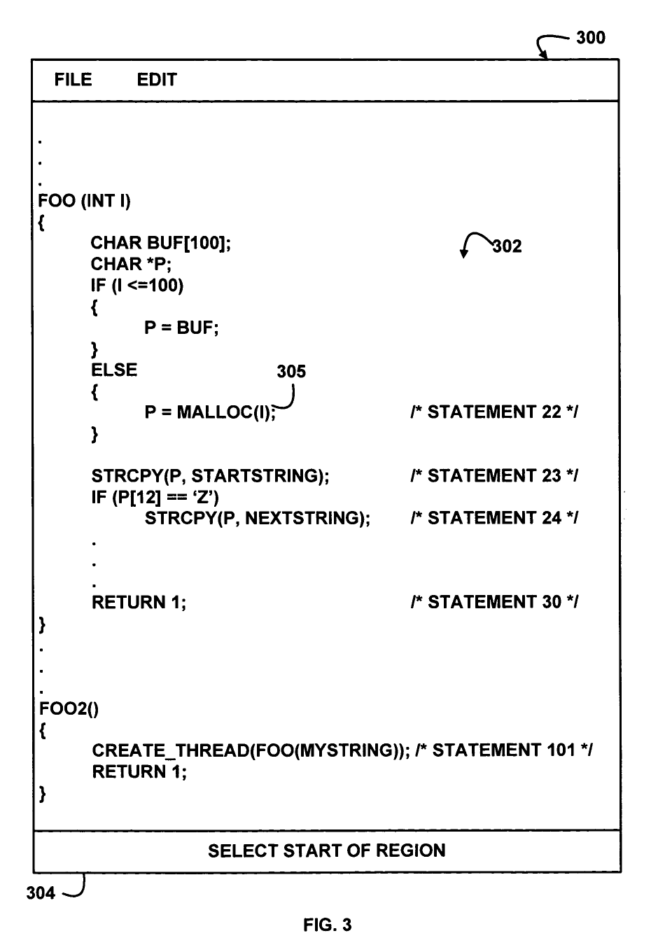

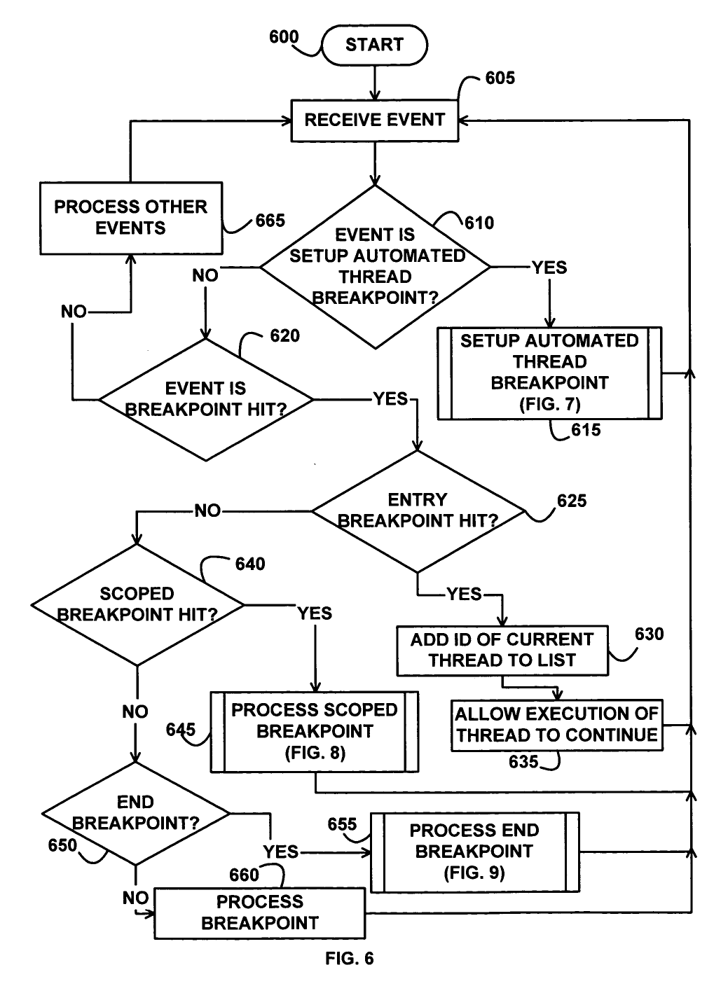

The debug controller 171 is used to debug the threads 172 via the breakpoint table 170. In an embodiment, the debug controller 171 includes instructions capable of executing on the processor 101 or statements capable of being interpreted by instructions executing on the processor 101 to access the data structure of FIG. 2, to present the user interfaces as further described below with reference to FIGS. 3, 4, and 5, and to perform the functions as further described below with reference to FIGS. 6, 7, 8, and 9. In another embodiment, the debug controller 171 may be implemented in microcode. In yet another embodiment, the debug controller 171 may be implemented in hardware via logic gates and/or other appropriate hardware techniques, in lieu of or in addition to a processor-based system.

The threads 172 represent multiple instances of the same program 173, which may execute concurrently, whether partially or completely on different processors 101 or on a single processor in a time-sharing environment. The threads 172 includes instructions capable of executing on the processor 101 or statements capable of being interpreted by instructions executing on the processor 101. The threads 172 may be debugged by the debug controller 171.

The memory bus 103 provides a data communication path for transferring data among the processors 101, the main memory 102, and the I/O bus interface unit 105. The I/O bus interface unit 105 is further coupled to the system I/0 bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124.

The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). Contents of the DASD 125, 126, and 127 may be stored to/loaded from the memory 102 as needed.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

It should be understood that FIG. 1 is intended to depict the representative major components of the computer system 100 at a high level, that individual components may have greater complexity that represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:
(1) information permanently stored on a non-rewriteable storage medium, e.g., a read-only memory device attached to or within a computer system, such as a CD-ROM readable by a CD-ROM drive;
(2) alterable information stored on a rewriteable storage medium, e.g., a hard disk drive (e.g., DASD 125, 126, or 127) or diskette; or
(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of an example data structure for the breakpoint table 170, according to an embodiment of the invention. The breakpoint table 170 includes records 205, 210, 215, 220, and 225, but in other embodiments any number of records with any appropriate data may be used Each of the records 205, 210, 215, 220, and 225 represents a breakpoint in the thread 172, as further described below with reference to FIGS. 3, 4, and 5.

Each record includes an address field 230, an operation code 235, a statement number 240, a type 245, an identifier 250, and an encountered thread identifier list 255, but in other embodiments the records may include more or fewer elements. The address field 230 indicates an address, whether relative or absolute, of a breakpoint within the threads 172. The operation code 235 indicates the contents at the address 230 (the instruction or statement) in the threads 172 where the breakpoint is set. The statement number 240 indicates the source code statement within the thread 172 where the breakpoint is set.

The type 245 indicates the type of the breakpoint. In the examples shown, types of breakpoints may be entry, scoped, end, or normal, but in other embodiments any appropriate type identifiers may be used.

A breakpoint with a type of entry (e.g., the breakpoint associated with the record 205) indicates the start of a region in the program 173. When the entry breakpoint is encountered by the execution of the thread 172, the debug controller 171 adds the thread identifier of the encountering thread 172 to the encountered thread identifier list 255 for the record that has the entry type (e.g., the record 205). But, the execution of the thread that encounters the entry breakpoint is not halted from the perspective of the user. That is, the execution of the thread may be temporarily halted, so that the debug controller 171 may be given control by the processor 101, but once the debug controller 171 is finished with its processing, the thread resumes without the debug controller 171 giving control to the user.

Breakpoints with a type of scoped (e.g., the breakpoints associated with the records 210 and 215) are scoped to the region associated with the entry 205 and the end 220 breakpoints, meaning that when a thread encounters a scoped breakpoint, the debug controller 171 looks for the thread identifier in the encountered thread identifier list 255. Although the example data illustrates multiple thread identifiers in the encountered thread identifier list 255, in other embodiments, the encountered thread identifier list 255 may be limited to a single thread identifier, where the first thread to encounter the entry breakpoint 205 is recorded in the encountered thread identifier list 255 and later threads are ignored until the first thread reaches the optional end breakpoint 220. If the current thread's identifier is in the encountered thread identifier list 255, then the breakpoint fires normally, meaning the execution of the thread is halted and control is given to the user. Otherwise, execution of the thread resumes without the user obtaining control. The identifier in the identifier field 250 of the scoped breakpoints matches the identifier in the associated entry and end breakpoints.

An end breakpoint (e.g., the breakpoint represented by the record 220) indicates the end of the region in the program 173. When the end breakpoint is encountered by the execution of the thread 172, the debug controller 171 removes that thread's identifier from the encountered thread identifier list 255. But, the execution of the thread that encounters the entry breakpoint is not halted from the perspective of the user.

When the execution of a thread encounters a breakpoint with a normal type (e.g., the breakpoint represented by the record 225), the execution of that thread is halted. Thus, the normal breakpoint is not scoped to the region bounded by the entry and end breakpoints, so the identifier field 250 in the record 225 does not match the identifier field 250 in the records 205, 210, 215, and 220.

The identifier 250 identifies the region that is defined by the entry breakpoint and the end breakpoint. The encountered thread identifier list 255 lists thread identifiers that have encountered the entry breakpoint. The data in the breakpoint table 170 is exemplary only, and in other embodiments any appropriate data may be used. The processing of the breakpoint table 170 by the debug controller 171 is further described below with reference to FIGS. 6, 7, 8, and 9.

FIG. 3 depicts a block diagram of an example user interface 300 for entering a start of a region, according to an embodiment of the invention. The user interface 300 includes a display 302 of the instructions or statements in the program 173. The user interface 300 further includes a message 304, which instructs the user to enter a start of the region.

In response to the message 304, the user has selected the start 305 of the region. The breakpoint associated with the start 305 of the region is represented by the record 205 (the entry breakpoint) in the breakpoint table 170 of FIG. 2, as previously described above. The user interface elements, code, and data are exemplary only, and in other embodiments any appropriate user interface elements, code, and data may be used.

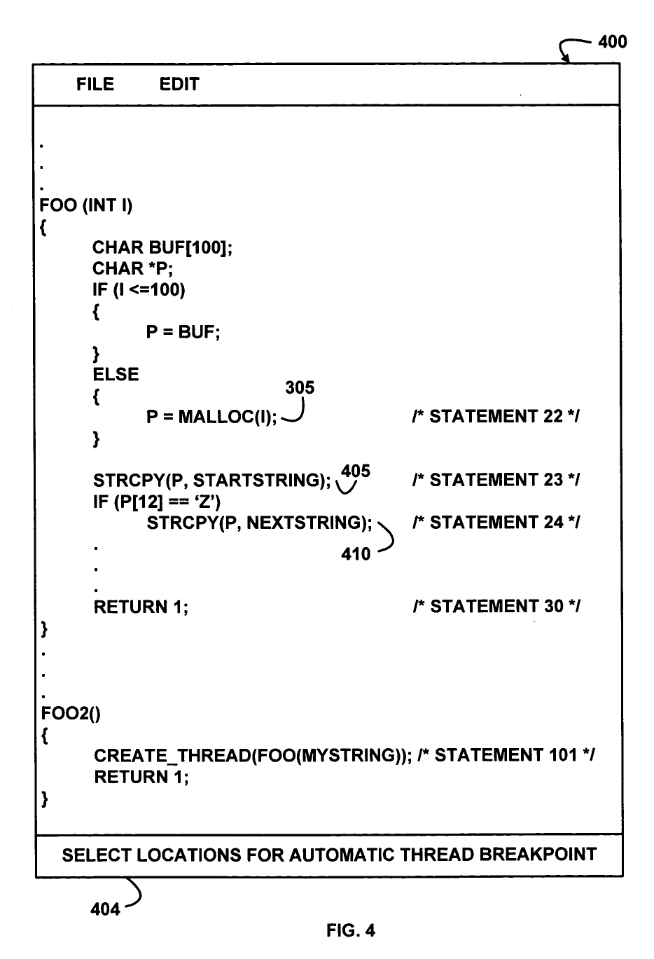

FIG. 4 depicts a block diagram of an example user interface 400 for entering automatic thread breakpoints in the program 173, according to an embodiment of the invention. The user interface 400 includes a message 404, which instructs the user to enter automatic thread breakpoints. In response to the message 404, the user has selected the automatic thread breakpoints 405 and 410. The breakpoints 405 and 410 are represented by the records 210 and 215, respectively, in the breakpoint table 170 of FIG. 2, as previously described above. Although the two breakpoints 405 and 410 are selected, in other embodiments any number of breakpoints may be selected. The user interface elements, code, and data are exemplary only, and in other embodiments any appropriate user interface elements, code, and data may be used.

Notice that some of the threads 172 that encounter the breakpoints 405 and 410 do not encounter the entry breakpoint 305 because the entry breakpoint 305 is executed conditionally since it is in an else leg program construct. But, in other embodiments the entry breakpoint may be part of any type of conditional construct, so that some threads of the threads 172 may have the opportunity to encounter the entry breakpoint 305 while others do not. Examples of conditional constructs include then legs, else legs, and jump tables, but any type of conditional construct may be used. Although the entry breakpoint 305 is illustrated as being in the same method as the automatic thread breakpoints 405 and 410, in other embodiments, the entry breakpoint 305 may be in a different function, method, or procedure, which is executed conditionally.

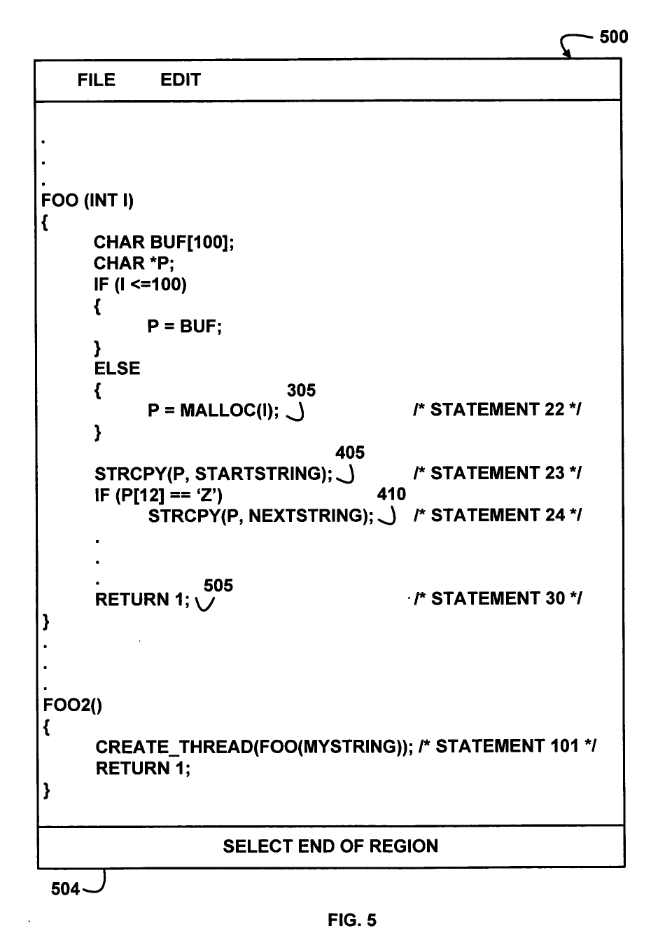

FIG. 5 depicts a block diagram of an example user interface 500 for entering an optional end of a region in the program 173, according to an embodiment of the invention. The user interface 500 includes a message 504, which instructs the user to enter an end of the region. In response to the message 504, the user has selected the end 505 of the region. The breakpoint associated with the end 505 of the region is represented by the record 220 in the breakpoint table 170 of FIG. 2, as previously described above. In an embodiment, the end 505 and the beginning 305 (FIG. 3) bound a region, which contains the scoped breakpoints 405 and 410. The user interface elements, code, and data are exemplary only, and in other embodiments any appropriate user interface elements, code, and data may be used.

FIG. 6 depicts a flowchart of example processing for the debug controller 171, according to an embodiment of the invention. Control begins at block 600. Control then continues to block 605 where the debug controller 171 receives an event. Control then continues to block 610 where the debug controller 171 determines whether the received event is a setup automated thread breakpoint event. In an embodiment, the setup automated breakpoint event occurs in response to the user selecting an entry, a scoped, or an end breakpoint, as previously described above with reference to FIGS. 3, 4, and 5. But, in other embodiments, the setup automated thread breakpoint event may occur programmatically with the participation of a user or without participation of a user.

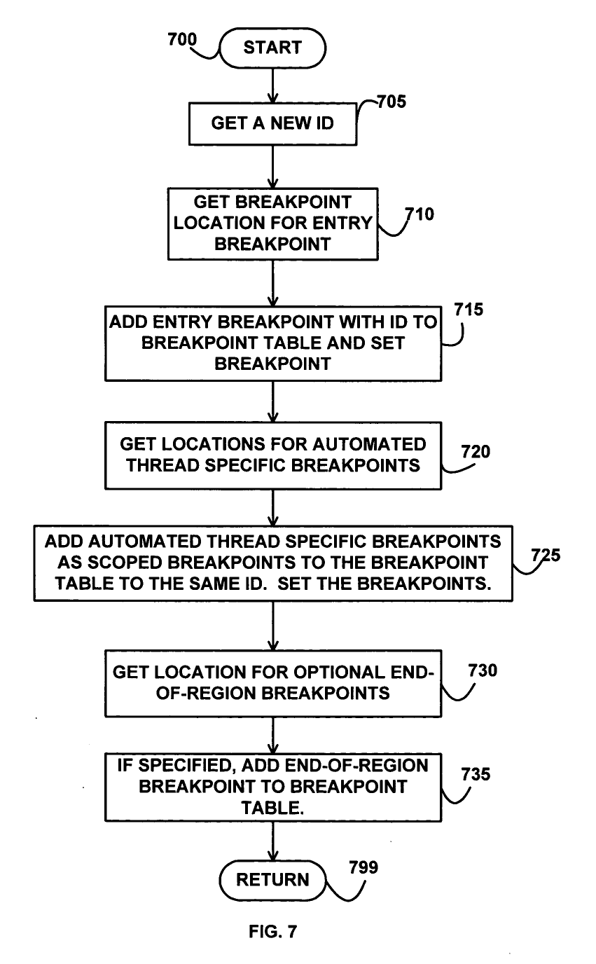

If the determination at block 610 is true, then the received event is a setup automated thread breakpoint event, so control continues to block 615 where the debug controller 171 sets up the automated thread breakpoint, as further described below with reference to FIG. 7. Control then returns to block 605 where the debug controller 171 receives another event, as previously described above.

If the determination at block 610 is false, then the received event is not a setup automated thread breakpoint event, so control continues to block 620 where the debug controller 171 determines whether the received event is a breakpoint hit event, which occurs in response to the thread 172 encountering a breakpoint. If the determination at block 620 is true, then the received event is a breakpoint hit event, so control continues to block 625 where the debug controller 171 determines whether the received event is an entry breakpoint hit event.

If the determination at block 625 is true, then the received event is an entry breakpoint hit event, so control continues to block 630 where the debug controller 171 adds the identifier of the current thread to the encountered thread identifier list 255 associated with the entry breakpoint that was hit. Control then continues to block 635 where the debug controller 171 allows execution of the thread to continue without giving control to the user. Control then returns to block 605, as previously described above.

If the determination at block 625 is false, then the received event is not an entry breakpoint hit event, so control continues to block 640 where the debug controller 171 determines whether the received event is a scoped breakpoint hit event.

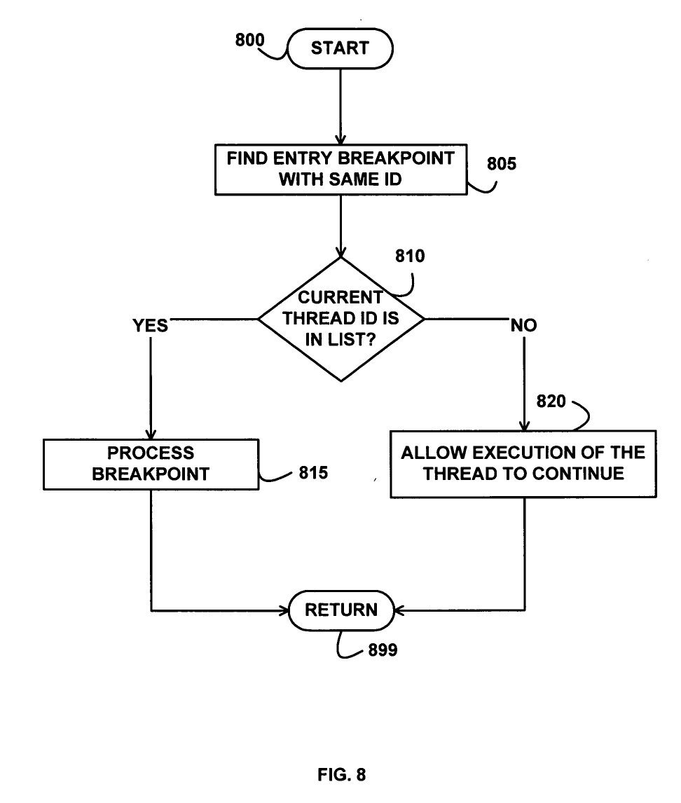

If the determination at block 640 is true, then the received event is a scoped breakpoint hit event, so control continues to block 645 where the debug controller 171 processes the scoped breakpoint that the thread encountered as further described below with reference to FIG. 8. Control then returns to block 605, as previously described above.

If the determination at block 640 is false, then the received event is not a scoped breakpoint hit event, so control continues to block 650 where the debug controller 171 determines whether the received event is an end breakpoint hit event.

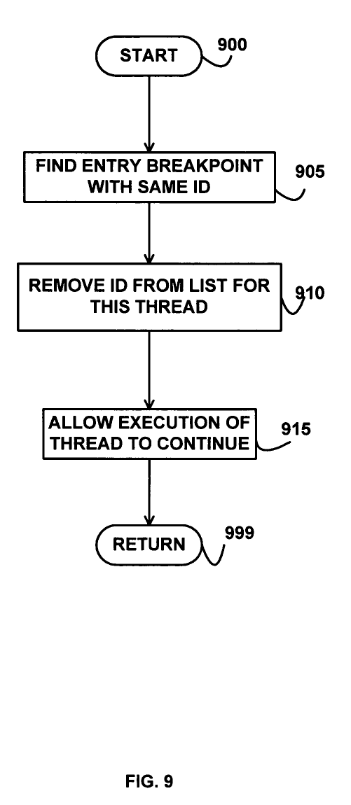

If the determination at block 650 is true, then the received event is an end breakpoint hit event, so control continues to block 655 where the debug controller 171 processes the end breakpoint that the execution of the thread 171 has encountered, as further described below with reference to FIG. 9. Control then returns to block 605, as previously described above.

If the determination at block 650 is false, then the received event is not an end breakpoint hit event, so control continues to block 660 where the debug controller 171 processes the normal breakpoint that execution of the thread 172 encountered. In an embodiment, the debug controller 171 may stop execution of the thread 172 that encountered the breakpoint and give control to the user. Control then returns to block 605, as previously described above.

If the determination at block 620 is false, then the received event is not a breakpoint hit event, so control continues to block 665 where the debug controller 171 processes other events. Control then returns to block 605, as previously described above.

FIG. 7 depicts a flowchart of example processing for a setup automated thread breakpoint function in the debug controller 171, according to an embodiment of the invention. Control begins at block 700. Control then continues to block 705 where the debug controller 171 creates or gets a new identifier for a region in the program 173. Control then continues to block 710 where the debug controller 171 gets a breakpoint location for the entry breakpoint, such as the entry breakpoint 305, as previously described above with reference to FIG. 3.

Control then continues to block 715 where the controller 171 adds the entry breakpoint with the identifier to the breakpoint table 170 (e.g., the record 205) and sets the breakpoint. Control then continues to block 720 where the debug controller 171 gets location(s) for the automated thread specific breakpoint(s), such as the locations 405 and 410, as previously described above with reference to FIG. 4. Control then continues to block 725 where the debug controller 171 adds the automated thread-specific breakpoints as scoped breakpoints to the breakpoint table 170, for example as records 210 and 215, as previously described above with reference to FIG. 2. The debug controller 171 gives these automated thread-specific breakpoints the same region identifier 250 as the entry breakpoint, which in the example of FIG. 2 is contained in entry 205. The debug controller 171 further sets the breakpoints.

Control then continues to block 730 where the debug controller 171 gets the location for an optional end-of-region breakpoint such as the location 505, as previously described above with reference to FIG. 5. Control then continues to block 735 where the debug controller 171 adds the end-of-region breakpoint, if specified, to the breakpoint table 170, for example, as the entry 220, as previously described above with reference to FIG. 2. Control then continues to block 799 where the logic of FIG. 7 returns.

FIG. 8 depicts a flowchart of example processing for a process scoped breakpoint function in the debug controller 171, according to an embodiment of the invention. Control begins at block 800. Control then continues to block 805 where the debug controller 171 finds the entry breakpoint in the breakpoint table 170 with the same identifier as the scoped breakpoint that was encountered by the thread 172. Control then continues to block 810 where the debug controller 171 determines whether the current thread identifier is in the encountered thread identifier list 255 for the entry breakpoint that was previously determined at block 805. If the determination at block 810 is true, then the current thread identifier is in the encountered thread identifier list 255, so control continues to block 815 where the debug controller 171 processes the breakpoint, stops execution of the thread 172 that encountered the scoped breakpoint and gives control to the user. Control then continues to block 899 where the logic of FIG. 8 returns.

If the determination at block 810 is false, then the current thread identifier is not in the encountered thread identifier list 255, so control continues to block 820, where the debug controller 171 allows execution of the thread 172 to continue. Control then continues to block 899 where the logic of FIG. 8 returns.

FIG. 9 depicts a flowchart of example processing for a process end breakpoint function in the debug controller 171, according to an embodiment of the invention. Control begins at block 900. Control then continues to block 905 where the debug controller 171 finds the entry breakpoint with the same region identifier 250 as the end breakpoint that was encountered by the thread 172. Control then continues to block 910 where the debug controller 171 removes the current thread identifier from the encountered thread identifier list 255. Control then continues to block 915 where the debug controller 171 allows execution of the current thread to continue. Control then continues to block 999 where the logic of FIG. 9 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

1. A method comprising:
determining whether a thread encountered a scoped breakpoint; and
if the determining is true, halting execution of the thread if the thread previously encountered an entry breakpoint.

2. The method of claim 1, further comprising:
if the determining is true, allowing execution of the thread to continue if the thread did not previously encounter the entry breakpoint.

3. The method of claim 1, wherein the scoped breakpoint is within a region bounded by the entry breakpoint and an end breakpoint.

4. The method of claim 1, wherein the entry breakpoint is executed conditionally.

5. An apparatus comprising:
means for determining whether a thread encountered a scoped breakpoint;
means for halting execution of the thread if the thread previously encountered an entry breakpoint and if the determining is true; and
means for allowing execution of the thread to continue if the thread did not previously encounter the entry breakpoint and if the determining is true.

6. The apparatus of claim 5, wherein the scoped breakpoint is within a region bounded by the entry breakpoint and an end breakpoint.

7. The apparatus of claim 5, wherein the entry breakpoint is executed conditionally.

8. The apparatus of claim 6, further comprising:
means for allowing execution of the thread to continue upon the thread encountering the entry breakpoint and the end breakpoint.

9. A signal-bearing medium encoded with instructions, wherein the instructions when executed comprise:
saving a definition of a region in a program bounded by an entry breakpoint and an end breakpoint;
if a thread encounters the entry breakpoint, saving an identifier of the thread;
if the thread encounters a scoped breakpoint within the region, determining whether the identifier was saved;
if the identifier was saved and the scoped breakpoint was encountered, halting execution of the thread; and
if the identifier was not saved and the scoped breakpoint was encountered, allowing execution of the thread to continue.

10. The signal-bearing medium of claim 9, further comprising:
allowing execution of the thread to continue upon the thread encountering the entry breakpoint; and
allowing execution of the thread to continue upon the thread encountering the end breakpoint.

11. The signal-bearing medium of claim 9, further comprising:
saving a definition of the scoped breakpoint within the region;

12. The signal-bearing medium of claim 9, further comprising:
after the thread encounters the end breakpoint, removing the saved identifier of the thread.

13. A computer system comprising:
a processor; and
memory encoded with instructions, wherein the instructions when executed on the processor comprise:
saving a definition of a region in a program bounded by an entry breakpoint and an end breakpoint, saving a definition of a scoped breakpoint within the region,
if a thread encounters the entry breakpoint, saving an identifier of the thread,
if the thread encounters the scoped breakpoint within the region, determining whether the identifier was saved,
if the identifier was saved and the scoped breakpoint was encountered, halting execution of the thread, and
if the identifier was not saved and the scoped breakpoint was encountered, allowing execution of the thread to continue.

14. The computer system of claim 13, wherein the instructions further comprise:
allowing execution of the thread to continue upon the thread encountering the entry breakpoint; and
allowing execution of the thread to continue upon the thread encountering the end breakpoint.

15. The computer system of claim 13, wherein the instructions further comprise:
after the thread encounters the end breakpoint, removing the saved identifier of the thread.

16. The computer system of claim 13, wherein the entry breakpoint is part of a conditional construct in the program.

17. A method of configuring a computer, wherein the method comprises:
configuring the computer to determine whether a thread encountered a scoped breakpoint; and
configuring the computer to halt execution of the thread if the thread previously encountered an entry breakpoint and if the thread encountered the scoped breakpoint.

18. The method of claim 17, further comprising:
configuring the computer to allow execution of the thread to continue if the thread did not previously encounter the entry breakpoint and if the thread encountered the scoped breakpoint.

19. The method of claim 17, wherein the scoped breakpoint is within a region bounded by the entry breakpoint and an end breakpoint.

20. The method of claim 17, wherein the entry breakpoint is executed conditionally.
